(19) United States
(12) Patent Application Publication
(10) Pub. No.: US 2025/0281855 A1
(43) Pub. Date: Sep. 11, 2025

(54) LIQUID FILTRATION CARTRIDGE AND A SYSTEM FOR LIQUIED FILTRATION

(71) Applicants: William S. Roche, Casselberry, FL (US); Owen Boyd, Westport, MA (US)

(72) Inventors: William S. Roche, Casselberry, FL (US); Owen Boyd, Westport, MA (US)

(21) Appl. No.: 18/599,185

(22) Filed: Mar. 7, 2024

(51) Int. Cl. B01D 27/08; B01D 29/21

(52) U.S. Cl. CPC B01D 27/08; B01D 29/21; B01D 2201/291; B01D 2221/02; B01D 2239/1216

(57) ABSTRACT

The present disclosure provides a filter cartridge, a filtration system and a process for filtering and disinfecting water for medical and/or dental purposes. Filter cartridge (10) comprises: (a) a vessel (16) comprising a first cavity; (b) a filter media (18) having a second cavity, wherein said filter media is disposed in said vessel thereby forming a first compartment therebetween an outer surface of said filter media (18) and an inner surface of said vessel (16); (c) a disinfectant media disposed in said second cavity; (d) a first end cap (14) attached to a first end of said vessel (16), wherein said first end cap (14) is configured to form a first outlet (12).

### FIELD OF THE INVENTION

The present disclosure relates to a liquid filtration cartridge, filtration system and process for liquid filtration and disinfection.

### BACKGROUND OF THE INVENTION

A feature common to dental treatment equipment is a water delivery system including a flexible conduit connected between the main water supply and a hand piece including a nozzle and a manual and/or automatic control operable to cause discharge of water from the nozzle to rinse the area of the patient's mouth upon which work is being done. The water is discharged only intermittently as needed, and water stands in the system for considerable intervals.

Various filter types may be used to remove harmful substances or microorganisms. Such filters include sediment filters, activated carbon filters, ultrafiltration hollow fiber membrane filters, reverse osmosis membrane filters, and the like. However, the current available commercial systems fail to provide cartridge and a system for optimum filtration and disinfection of water for dental treatment purposes. It is highly desirable to disinfect and remove micro-organisms and other undesirable contaminants and/or particles from the water for medical or dental treatment usage, so that the water will be decontaminated and sanitary for such medical or dental use.

### SUMMARY OF THE INVENTION

The present disclosure provides a filter cartridge, a filtration system and a process for filtering and disinfecting water for medical and/or dental purposes.

In one embodiment, referring to FIGS. 5-17, filter cartridge (10) comprises: (a) a vessel (16) comprising a first cavity; (b) a filter media (18) having a second cavity, wherein said filter media is disposed in said vessel thereby forming a first compartment therebetween an outer surface of said filter media (18) and an inner surface of said vessel (16); (c) a disinfectant media disposed in said second cavity; (d) a first end cap (14) attached to a first end of said vessel (16), wherein said first end cap (14) is configured to form a first outlet (12).

In an alternative embodiment, the present disclosure provides a filtration system (11) comprising: (a) a water reservoir (20); (b) an air pressure source (24); and (c) a filter cartridge (10) comprises: (a) a vessel (16) comprising a first cavity; (b) a filter media (18) having a second cavity, wherein said filter media is disposed in said vessel thereby forming a first compartment therebetween an outer surface of said filter media (18) and an inner surface of said vessel (16); (c) a disinfectant media disposed in said second cavity; (d) a first end cap (14) attached to a first end of said vessel (16), wherein said first end cap (14) is configured to form a first outlet (12).

In an alternative embodiment, the present disclosure provides a process for filtering water comprising the steps of: (a) providing a filtration); (em (11) comprising; (i) a water reservoir (11); (ii) an air pressure source (24); and (iii) a filter cartridge (10) comprises: (a) a vessel (16) comprising a first cavity; (b) a filter media (18) having a second cavity, wherein said filter media is disposed in said vessel thereby forming a first compartment therebetween an outer surface of said filter media (18) and an inner surface of said vessel (16); (c) one or more disinfectant media disposed in said second cavity; (d) a first end cap (14) attached to a first end of said vessel (16), wherein said first end cap (14) is configured to form a first outlet (12); (b) providing water in said water reservoir; (c) pressurizing said water via said air pressure source (24); (d) channeling said pressurized water from said water reservoir via said one or more openings into the second cavity and in contact with said one or more disinfectant media; thereby filtering said water and disinfecting it before exiting said filtration system via said first outlet (12).

### BRIEF DESCRIPTION OF DRAWINGS

For the purpose of illustrating the invention, there is shown in the drawings a form that is exemplary; it being understood, however, that this invention is not limited to the precise arrangements and instrumentalities shown.

FIG. 1a is a side view of a filtration system;

FIG. 2 is a perspective view of a filtration system;

FIG. 3 is an exploded view of a filtration system;

FIG. 4 is a side view of a filtration system removing a portion of dental water bottle showing filter cartridge disposed therein;

FIG. 4a is a first embodiment of a filter media;

FIG. 4b is a second embodiment of a filter media;

FIG. 4c is a cross-sectional view of a second embodiment of a filter media;

FIG. 4d is a cross-sectional view of a first embodiment of a filter media;

FIG. 5 is a second embodiment of a filter media;

FIG. 6 is a first embodiment of a filter media;

FIGS. 8 & 9 are front view and side view of a second embodiment of a filter media;

FIGS. 10 & 11 or top view and bottom view of a second embodiment of a filter media, respectively;

FIG. 12 is top view of a first embodiment of a filter media;

FIGS. 13 & 14 are front view and side view of a first embodiment of a filter media;

FIG. 15 is bottom view of a first embodiment of a filter media;

FIGS. 16 & 17 are exploded views of a first & second embodiment of a filter media, respectively;

FIG. 18 is a side view of a filtration system illustrating water flow through the system; and

FIG. 19 is a longitudinal cross-sectional view of a filter cartridge.

### DETAILED DESCRIPTION OF THE INVENTION

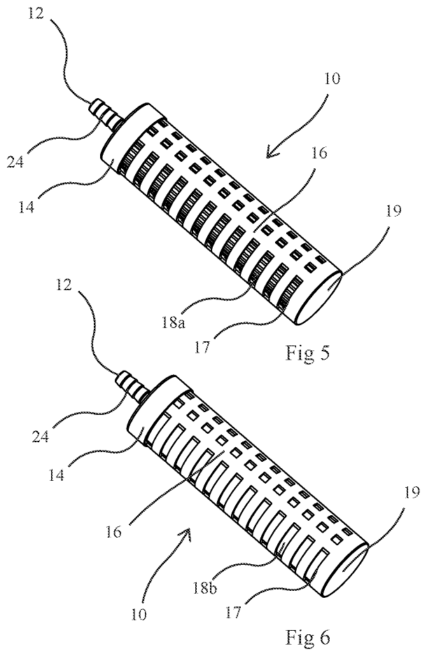

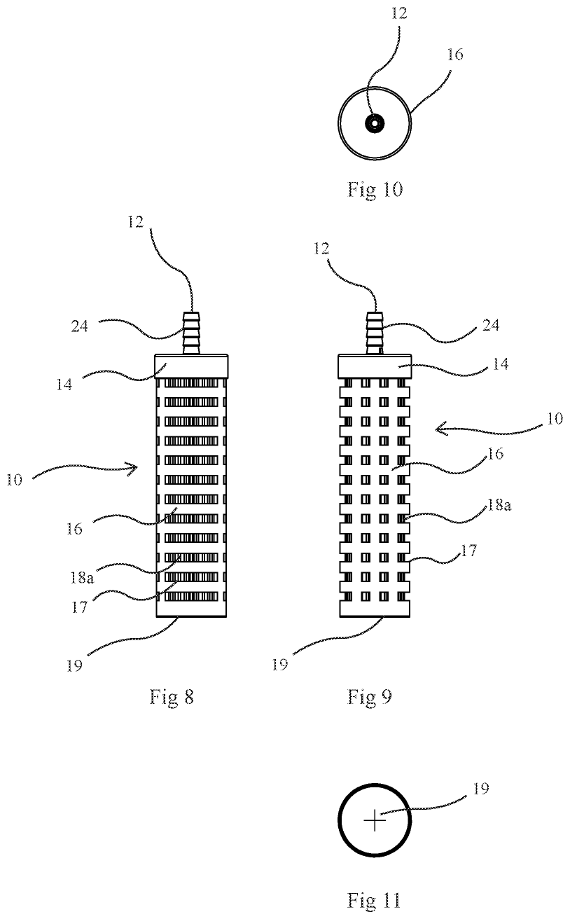

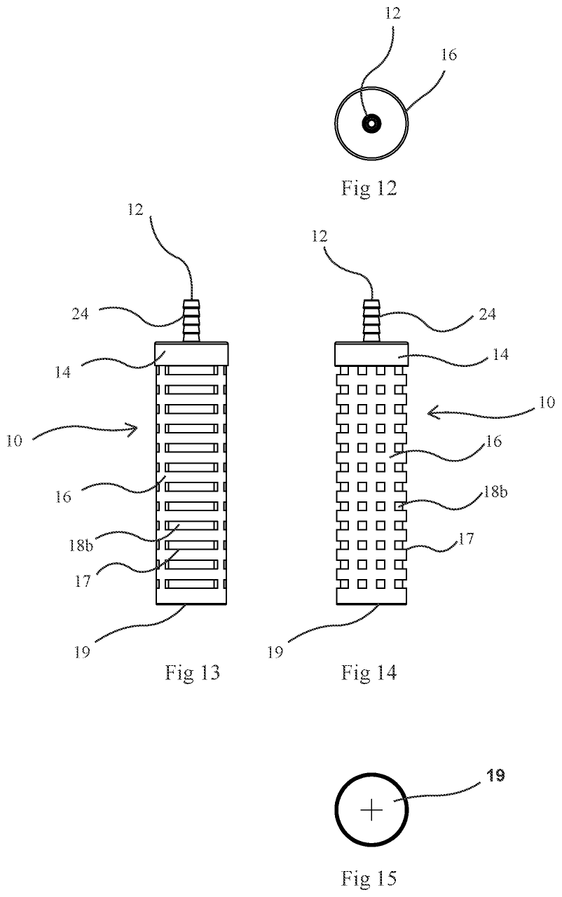

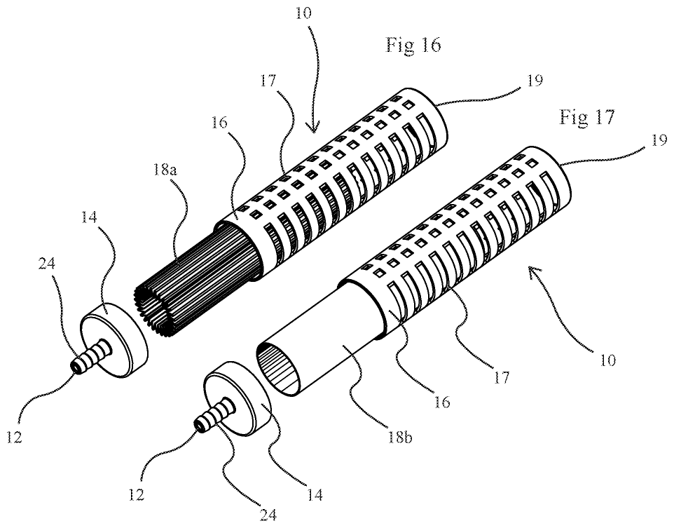

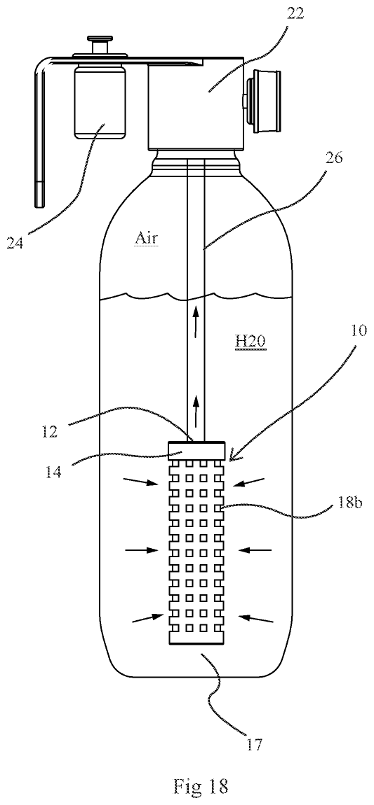

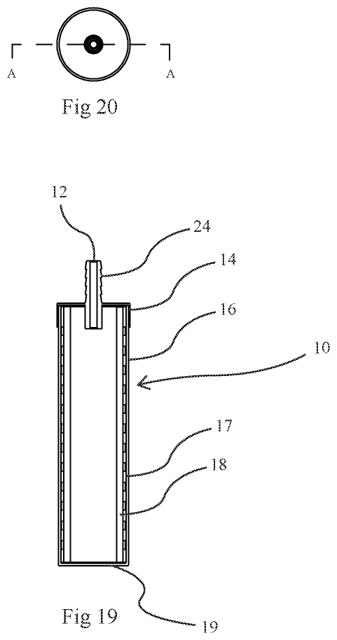

The present disclosure provides a filter cartridge, a filtration system and a process for filtering and disinfecting water for medical and/or dental purposes. In one embodiment, referring to FIGS. 5-17, filter cartridge (10) comprises: (a) a vessel (16) comprising a first cavity; (b) a filter media (18) having a second cavity, wherein said filter media is disposed in said vessel thereby forming a first compartment therebetween an outer surface of said filter media (18) and an inner surface of said vessel (16); (c) a disinfectant media disposed in said second cavity; (d) a first end cap (14) attached to a first end of said vessel (16), wherein said first end cap (14) is configured to form a first outlet (12). First outlet 12 can extend outwardly and can comprise one or more angled away projections (24). Vessel (16) comprises a first cavity configured to receive a filter media (18). Vessel (16) can be made from any polymeric materials. Such polymeric materials include, but are not limited to, polyolefins such as polyethylene, polypropylene and combinations thereof. In one embodiment Vessel (16) can be made from a protective mesh. Vessel (16) can be made via any method including, but not limited to, injection molding or the like. Vessel (16) can comprise one or more openings (17). One or more openings (17) may have any shape, for example, one or more openings (17) may have a shape selected from the group consisting of square, circle, oval, rectangle, or the like. In one embodiment, One or more openings (17) may have an irregular shape. In one embodiment, the filter media is coupled to the vessel and the first end cap thereby forming filtration path through said one or more openings into the first compartment, and then into the second cavity and subsequently out via an outlet in the first end cap.

The filter media is a filtration material having a pore size in the range of 0.9 to 1.8μ nominal. In one embodiment, the filter media is pleated, and in an alternative embodiment, filter media is flat and preferably in a tubular shape. The filter media can have any thickness, for example the filter media can have a thickness in the range of from 1 mm to 2 mm. In one embodiment, the filter media is hydrophobic. In one embodiment, the filter media is capable of removing particles having a diameter in the range of less than 800μ, for example, less than 400μ, or less than 200μ, or less than 100μ, or less than 10μ, or less than 1μ. In one embodiment, the filter media is capable of removing particles having a diameter in the range of from 20 to 800μ, or in the alternative from 20 to 400μ.

The filter media is capable of withstanding a pressure in the range of up to 120 psi, for example, the filter media is capable of withstanding a pressure in the range of 10 to 80 psi, for example, in the range of 15 to 30 psi (nominal). The filter media is also capable of removing substantial portion of bacteria, virus, cysts, and combinations thereof, for example, the filter media is capable of removing at least 99.99% of the bacteria, virus, cysts and combinations thereof. Such filter media is commercially available from Ahlstrom under the trade name Ahlstrom Disruptor 5288.

Filter media can be pleated or flat. Filter media may be formed into a circular shape configured to be disposed in the vessel.

The disinfectant media can be any material, in one embodiment, the disinfectant media is selected from the group consisting of iodine, silver, ion exchange resin, carbon, combinations thereof, and the like. In one embodiment, the disinfectant media comprises a solid composition.

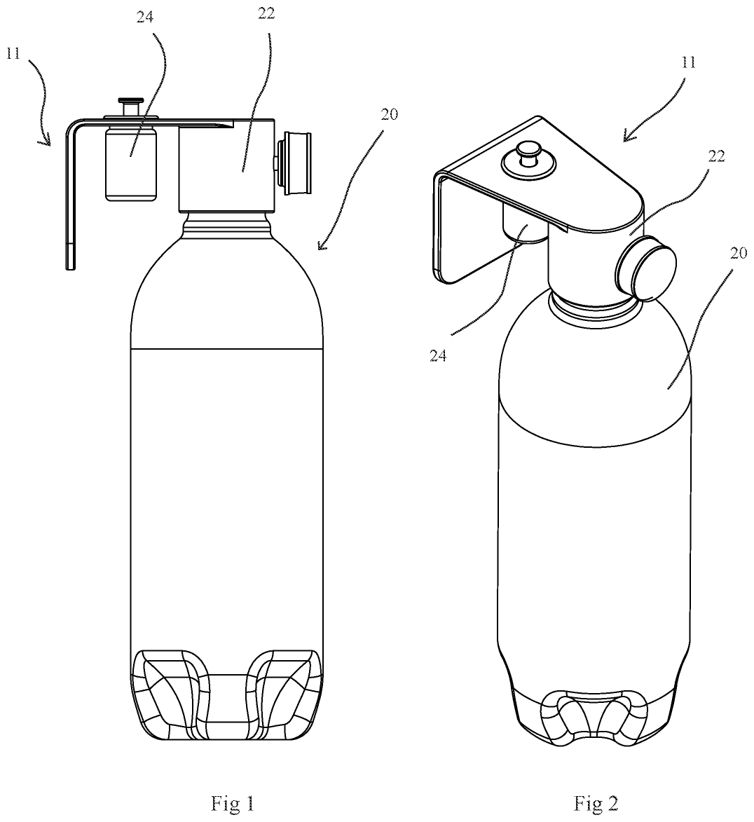

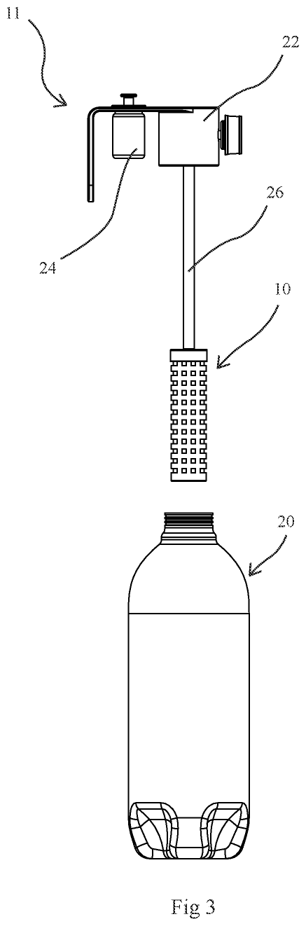

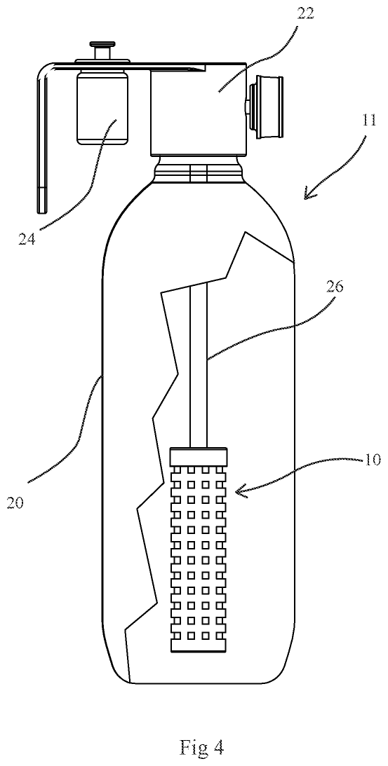

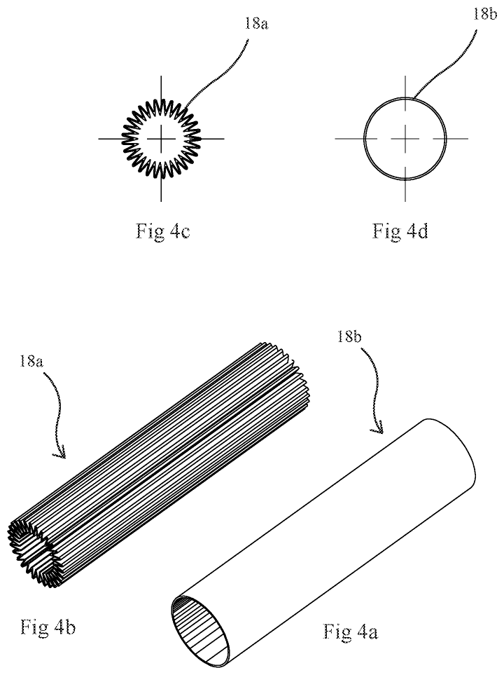

In an alternative embodiment, referring to FIGS. 1-4 & 18, the present disclosure provides a filtration system (11) comprising: (a) a water reservoir (20); (b) an air pressure source (24); and (c) a filter cartridge (10) comprises: (a) a vessel (16) comprising a first cavity; (b) a filter media (18) having a second cavity, wherein said filter media is disposed in said vessel thereby forming a first compartment therebetween an outer surface of said filter media (18) and an inner surface of said vessel (16); (c) a disinfectant media disposed in said second cavity; (d) a first end cap (14) attached to a first end of said vessel (16), wherein said first end cap (14) is configured to form a first outlet (12).

In an alternative embodiment, In an alternative embodiment, referring to FIG. 18, the present disclosure provides a process for filtering water comprising the steps of: (a) providing a filtration system (11) comprising; (i) a water reservoir (20); (ii) an air pressure source (24); and (iii) a filter cartridge (10) comprises: (a) a vessel (16) comprising a first cavity; (b) a filter media (18) having a second cavity, wherein said filter media is disposed in said vessel thereby forming a first compartment therebetween an outer surface of said filter media (18) and an inner surface of said vessel (16); (c) one or more disinfectant media disposed in said second cavity; (d) a first end cap (14) attached to a first end of said vessel (16), wherein said first end cap (14) is configured to form a first outlet (12). First outlet 12 can extend outwardly and can comprise one or more angled away projections (24); (b) providing water in said water reservoir; (c) pressurizing said water via said air pressure source (24); (d) channeling said pressurized water from said water reservoir via said one or more openings into the second cavity and in contact with said one or more disinfectant media; thereby filtering said water and disinfecting it before exiting said filtration system via said first outlet (12).

The present invention may be embodied in other forms without departing from the spirit and the essential attributes thereof, and, accordingly, reference should be made to the appended claims, rather than to the foregoing specification, as indicating the scope of the invention.

We claim:

1. A filter cartridge comprising:
a. a vessel comprising a first cavity;
b. a filter media having a second cavity disposed in the vessel thereby forming a first compartment therebetween an outer surface of the filter media and an inner surface of the vessel;
c. a disinfectant media disposed in the second cavity;
d. a first end cap attached to a first end of the vessel, wherein the first end cap is configured to form a first outlet.

2. The filter cartridge of claim 1, wherein the vessel comprises one or more polymers.

3. The filter cartridge of claim 1, wherein the filter cartridge is configured to be disposed in a dental chair water reservoir.

4. The filter cartridge of claim 1, wherein the vessel comprises one or more openings.

5. The filter cartridge of claim 1, wherein the filter media is pleated.

6. The filter cartridge of claim 1, wherein the filter media is tubular shape.

7. The filter cartridge of claim 1, wherein the filter media has thickness in the range of 1 mm to 2 mm.

8. The filter cartridge of claim 1, wherein the filter media is hydrophobic.

9. The filter cartridge of claim 1, wherein the filter media has a pore size in the range of from 0.9 to 1.8 micron nominal.

10. The filter cartridge of claim 1, wherein the filter media is capable of removing particles having a diameter in the range of from 20 to 800 nm.

11. The filter cartridge of claim 1, wherein the filter media is capable of removing particles having a diameter in the range of from 20 to 400 nm.

12. The filter cartridge of claim 1, wherein the filter media is capable of withstanding a pressure in the range of up to 80 psi.

13. The filter cartridge of claim 1, wherein the filter media is capable of removing substantial portion of bacteria, virus, cysts, and combinations thereof.

14. The filter cartridge of claim 4, wherein the filter media is coupled to said vessel and said first end cap thereby forming filtration path through the one or more openings into the first compartment, and then into the second cavity and subsequently out via an outlet in first end cap.

15. The filter cartridge of claim 1, wherein the disinfectant media comprises iodine, silver or combinations thereof.

16. The filter cartridge of claim 1, wherein the disinfectant media comprises a solid or a liquid composition.

17. The filter cartridge of claim 1, wherein the first outlet extends outwardly and comprises one or more angled away projections.

18. A filtration system comprising:
a. a water reservoir;
b. an air pressure source; and
c. a filter cartridge comprising:
a vessel comprising a first cavity;
a filter media having a second cavity disposed in the vessel thereby forming a first compartment therebetween an outer surface of the filter media and an inner surface of the vessel;
a disinfectant media disposed in the second hollow cavity;
a first end cap attached to a first end of the vessel, wherein the first end cap is configured to form a first outlet.

19. A process for filtering water comprising the steps of:
a. providing a filtration system comprising;
a water reservoir;
an air pressure source; and
a filter cartridge comprising:
a vessel comprising a first cavity and one or more openings;
a filter media having a second cavity disposed in the vessel thereby forming a first compartment therebetween an outer surface of the filter media and an inner surface of the vessel;
a disinfectant media disposed in the second cavity;
a first end cap attached to a first end of said vessel, wherein the first end cap is configured to form a first outlet;
b. providing water in the water reservoir;
c. pressurizing the water via said air pressure source; and
d. channeling the pressurized water from the water reservoir via the one or more openings into the second cavity and in contact with the disinfectant media;
thereby filtering and disinfecting the water before exiting the filtration system via the first outlet.
